(19) United States
(12) Patent Application Publication
(10) Pub. No.: US 2024/0426279 A1
(43) Pub. Date: Dec. 26, 2024

(54) Robotic-Centrifugal Energy Generator

(71) Applicant: Olvin Ivan Castro Martinez, South Fallsburg, NY (US)

(72) Inventor: Olvin Ivan Castro Martinez, South Fallsburg, NY (US)

(21) Appl. No.: 18/211,590

(22) Filed: Jun. 20, 2023

(51) Int. Cl. F03G 3/06; H02K 37/24

(52) U.S. Cl. CPC F03G 3/06; H02K 37/24; F05B 2220/7066; F05B 2260/4021; F05B 2270/502

(57) ABSTRACT

A robotic centrifugal apparatus to generate energy comprising stepper motors, belt drive, sliders, motor generator, pendulum, belt, switch sensor and reflective flanges. The apparatus functions expending low consumption of electricity to produce energy by taking advantage of the gravity which allows the centrifugal motion to produce torque when the pendulum moves downscale. A linear and horizontal motion from one side to another is made by a robotic system synchronized of a stepper motor, belt drive, slider, and a setting of switch sensor with reflective flanges to excite the motion of the pendulum at 360 degrees of rotation continuously, through getting mechanical motion to generate energy. A second stepper motor helps to stabilize the speed of the pendulum rotation specially when the pendulum moves upscale due to the force of gravity slowing down the rotation speed of the pendulum.

### FIELD

The present application relates to an optimizer of energy generator that works using a robotic, mechanic, and centrifugal design. Which includes stepper motors, belt drive, slider, motor generator, switch sensor and a pendulum allowing a mechanical motion to generate energy.

### BACKGROUND

There is a challenge of spreading the energy generation avoiding the gas emissions that affect the climate change, so there are many types of energy generations like solar panel, wind turbine generators, nuclear energy. Nowadays those type of energy generation are increasing operations around the world, specific energy generator that is friendly with the environment, also they have been spreading operation as an answer for the energy deficit that some countries are currently facing.

This invention has a different input of mechanical motion to generate energy because it does not use the wind, gas emission, hydroelectric or magnet settings to produce energy. Basically, this apparatus spends a low consumption of energy to generate a high production of energy by using robotic and mechanic system; the use of stepper motor, belt drive and slider to excite the centrifugal motion of a pendulum that allow the mechanical motion of a generator.

There are many patents of energy generator like solar, wind, hydroelectric but there is not one similar like this apparatus. For that instance, the invention does not have an actual patent improvement to mention.

### SUMMARY

The invention proposed, uses a stepper motor that make motion to a belt drive clockwise and counterclockwise rotation. The belt drive has mounted a slider that makes a linear motion. The slider gets far away from the stepper motor when the stepper motor does a clockwise rotation, and the slider gets closer to the stepper motor when the stepper motor makes a counterclockwise rotation. There is a motor generator in the platform of the slider. The invention also uses a pendulum that has a metal ball connected to a metal rod, said metal bar is joint to a crankshaft. The crankshaft has one tip connected to the crankshaft of the motor generator and another tip placed in a block mounted bearing. The block mounted bearing is joint to the platform of a slider. The slider is mounted in two linear slide rails. Also, the invention uses a stepper motor that has a belt to rotate the crankshaft of the pendulum. This invention uses a switch sensor and two reflective flanges, said reflective flanges are assembled to the crankshaft of the pendulum. One reflective flange activates the sensor switch signal when the pendulum moves downscale counterclockwise, so the stepper motor allows the linear motion of the slider to get the pendulum far from the stepper motor. Also, the motor generator, crankshaft of pendulum, block mounted bearing, belt and stepper motor assembled into the slider platform moves it far away from the stepper motor that rotates the belt drive. The other reflective flange activates the switch sensor signal when the pendulum moves upscale, so the stepper motor receives signal to switch rotation allowing the slider change motion to get close to the stepper motor. Therefore, the motor generator, crankshaft of pendulum, the slider, block mounted bearing, stepper motor assembled into the slider and belt, change the linear motion to get close to the stepper motor that rotates the belt drive. Therefore, the invention allows an exciting linear motion that helps to reach the rotation of the pendulum at 360 degrees, also the gravitational force produces torque when the pendulum makes centrifugal motion downscale, and the centrifugal motion plus the exciting linear motion allow to get the pendulum to rotate upscale. Therefore, the pendulum, specifically the force weight of the pendulum ball, and the robotic mechanism allow the mechanical force to rotate the crankshaft of the motor generator to produce energy. The stepper motor that is assembled to the slider helps to stabilize the speed of the rotation of the pendulum, specially when the pendulum makes a centrifugal motion upscale.

### BRIEF DESCRIPTION OF DRAWINGS

There are two drawings that will show the apparatus of the invention, also a good comprehension of the invention. Those drawing are:

FIG. 1: Pendulum Apparatus.

FIG. 2: Pendulum Rotation Configuration.

### DETAILED DESCRIPTION OF DRAWINGS

In the following explanation, it will show the description of each element of the invention. A detailed explanation of how the apparatus functions.

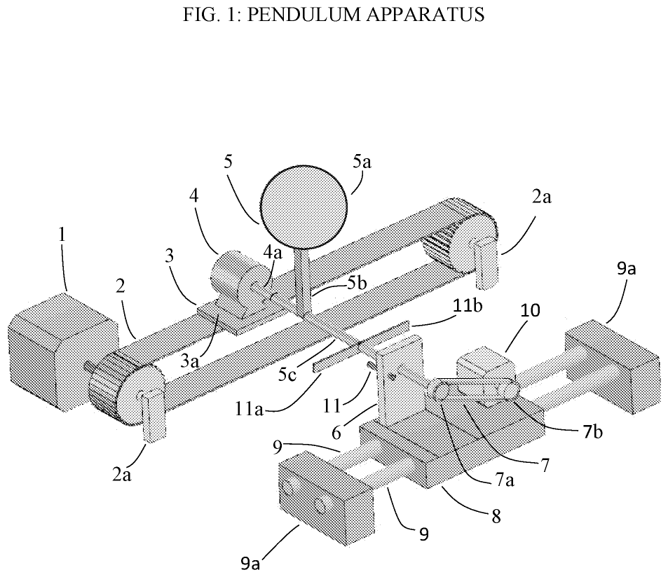

In FIG. 1 the stepper motor 1 rotates the belt drive 2 at counterclockwise and clockwise rotation. The belt drive 2 is assembled to a base of the slider mechanism 2a, said belt drive 2 makes linear motion to a slider 3. The stepper motor 1 rotates the belt drive to at clockwise allowing the slider 3 to move far away from the stepper motor 1 linearly. The stepper motor 1 rotates the belt drive 2 to at counterclockwise allowing the slider 3 to move close to the stepper motor 1. A motor generator 4 is assembled to a slider platform 3a. a Pendulum 5 contains a metal ball 5a, a metal rod 5b and a crankshaft of the pendulum 5c. One side of the crankshaft's tip of the pendulum 5c is connected to the crankshaft of the motor generator 4a and the other pendulum tip is placed into a block mounted bearing 6. The block mounted bearing 6 is assembled to a slider 8, said slider 8 is mounted in two linear slide rail 9, said linear slide rail 9 has a base of rail 9a. A stepper motor 10 places a synchronous wheel 7b. The synchronous wheel 7b contains a belt 7, said belt 7 is placed on a synchronous wheel 7a, said synchronous wheel 7a places in the crankshaft of pendulum 5c. The stepper motor 10 rotates the pendulum 5 through the belt 7. The function of the stepper motor 10 is to improve the rotation speed of the pendulum 5 specially when the pendulum 5 rotates upscale. A switch sensor 11 places into the block mounted bearing 6, a reflective flange 11a it places on the crankshaft of the pendulum 5c, another reflective flange 11b places in the crankshaft of the pendulum 5c, too. The reflective flange 11a activates a signal of the switch sensor 11 to achieve the slider 3 which moves far away from the stepper motor 1 when the pendulum 5 rotates downscale and the reflective 11b activates the signal of the switch sensor 11 to achieve the slider 3 moves close to the stepper motor 1 when the pendulum 5 rotates upscale. therefore, the pendulum 5 gets the cycle of 360 degree to keep the rotation continuously at counterclockwise, allowing the mechanical motion that requires the motor generator 4 to produce energy.

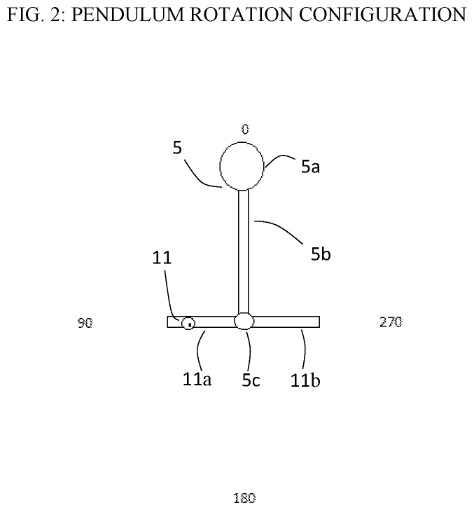

In the FIG. 2 it illustrates the method of the horizontal motion of a crankshaft axis of the pendulum 5c to get exciting motion to achieve the rotation of a pendulum 5 at 360 degrees continuously. The components showed in the FIG. 2 are the same mentioned in the FIG. 1. A pendulum 5 contains a metal ball 5a, a metal rod 5b and a crankshaft of pendulum 5c. A switch sensor 11 which works with reflective flange 11a and reflective flange 11b. In the FIG. 2 shows a counterclockwise rotation degree, a pendulum 5 at 0 degrees, a switch sensor 11 at 90 degrees, a reflective flange 11a at 90 degrees and a reflective flange 11b at 270 degrees. When the pendulum 5 rotates at 0 degrees, the reflective flange 11a rotates at 90 degrees, said reflective flange 11a places in the position of the switch sensor 11 at 90 degrees allowing an activation of the signal to achieve the slider 3 mentioned in FIG. 1, moves far away from the stepper motor 1 mentioned in FIG. 1. Said motion allows to move the axis of the crankshaft of pendulum 5c horizontally to the side that shows the 270 degrees in the FIG. 2. When the pendulum 5 rotates from 0 degrees to 180 degrees, the reflective flange 11b rotates from 270 degrees to 90 degrees. Said reflective flange 11b places in the contact signal with the switch sensor 11 allowing an activation of the signal to achieve the switching motion of the slider 3 mentioned in FIG. 1, to close to the stepper motor 1 mentioned in FIG. 1. The axis of the crankshaft of pendulum 5c changes the horizontal motion to the opposite side of the 270 degrees, getting closer to 90 degrees. This horizontal motion from one side to the other side linearly, with the synchronized motion of the crankshaft of pendulum 5c allows the exciting motion to rotate the pendulum 5, therefor the motor generator 4 mentioned in FIG. 1, receives that mechanical motion to produce energy.

1. A robotic-centrifugal energy generator apparatus comprising: two stepper motors, a belt drive, two sliders, a motor generator, a pendulum, a belt, a reflective switch sensor and two reflective flanges.

2. A device of the claim 1, wherein the first stepper motor receives input signal from the switch sensor, said stepper motor rotates the belt drive counterclockwise and clockwise directions.

3. A device of the claim 1, wherein the belt drive moves the first slider linear and horizontally at two directions.

4. A device of the claim 1, wherein the first slider carries the motor generator, said motor generator is connected to the crankshaft of the pendulum, said motor generator and crankshaft of pendulum has the same linear and horizontal motion of said slider.

5. A device of the claim 1, wherein the motor generator receives mechanical motion from the pendulum.

6. A device of the claim 1, wherein the pendulum contains a heavy metal ball, a metal rod, and a crankshaft, said crankshaft carries a synchronous wheel and the two reflective flanges.

7. A device of the claim 1, wherein the second stepper motor has the same linear and horizontal motion of the slider, said stepper motor has a synchronous wheel, said synchronous wheel contain a belt, said belt rotates the crankshaft of the pendulum.

8. A device of the claim 1, wherein the switch sensor has the same vertical and horizontal motion of the first slider, said switch sensor works with two reflective flanges.

9. A device of the claim 1, wherein the first reflective flange activates a signal of the switch sensor, said switch sensor change the rotation of the stepper motor, said stepper motor changes the linear and horizontal motion of the first slider, the motor generator, and the crankshaft axis of pendulum. Said crankshaft axis of the pendulum moves to the opposite side where the metal ball of the pendulum rotates downscale.

10. A device of the claim 1, wherein the second reflective flange activates the signal of the switch sensor, said switch sensor change the rotation of the stepper motor, said stepper motor changes the linear and horizontal motion of the slider, the motor generator, the crankshaft axis of pendulum. Said crankshaft axis of pendulum moves to the opposite side where the metal ball of the pendulum rotates upscale.
